(19) United States
(12) Patent Application Publication
(10) Pub. No.: US 2012/0107771 A1
(43) Pub. Date: May 3, 2012

(54) Removable Partial Dental Prosthesis

(76) Inventor: Carol Hrenak, Juneau, WI (US)

(21) Appl. No.: 12/917,281

(22) Filed: Nov. 1, 2010

(51) Int. Cl. A61C 13/007

(52) U.S. Cl. 433/171; 433/202.1

(57) ABSTRACT

The present invention is a removable partial dental prosthesis comprised of a plastic framework. One or more acrylic prosthetic teeth are chemically bonded to the framework using dental acrylic.

### FIELD OF INVENTION

The present invention relates to the field of dental prostheses and more particularly to removable partial dental prostheses.

### BRIEF DESCRIPTION OF THE DRAWINGS

FIG. 1 illustrates an exploded view of an exemplary embodiment of a removable partial dental prosthesis and a model.

FIG. 2 illustrates a top perspective view of an exemplary embodiment of a removable partial dental prosthesis fitted on a model.

FIG. 3 illustrates an exploded view of an exemplary embodiment of a removable partial dental prosthesis.

FIG. 4 illustrates a sectional view of an exemplary embodiment of a removable partial dental prosthesis.

### GLOSSARY

As used herein, the term “chemical bond” refers to the attraction between atoms or molecules of two chemical substances that holds the two substances together.

As used herein, the term “mechanical bond” refers to the use of contours, cuts, apertures, and/or interlocking components to hold two or more components together. For example, a prosthetic tooth may be mechanically bonded to the frame of a dental prosthesis by making contours, cuts, and apertures in the prosthetic tooth so that the frame can engage the prosthetic tooth.

As used herein, the term “abutment teeth” refers to a patient's natural teeth which are used to support a removable partial dental prosthesis.

As used herein, the term “framework” refers to the structure that supports one or more prosthetic teeth.

As used herein, the term “base material” refers to the substance or substances that comprise the framework.

As used herein, the term “thermosetting plastic” refers to a polymer material that irreversibly cures.

As used herein, the term “prosthetic teeth” refers to material, such as plastic or porcelain, formed in the shape of teeth.

As used herein, the term “dental acrylic” refers to a mixture of monomer and polymer that is cured by heat or cold and which may be used to bind prosthetic teeth to the framework.

As used herein, the term “model” refers to a full or partial replica of a patient's teeth and gums.

As used herein, the term “path of insertion” refers to the direction in which a dental prosthesis is placed upon or removed from the supporting tissues or abutment teeth. A dental prosthesis may be modified to add or reduce the space within a prosthetic device to facilitate placement of the prosthetic device over teeth.

As used herein, the term “polishing” refers to the smoothing of the surface of a prosthetic device using burrs, wheels, and/or polishing agents known in the art.

As used herein, the term “surveying” refers to the process of analyzing the contours of a model using any dental surveying tool known in the art for calculating the curvature of the teeth to identify undercut's in the patient's natural teeth which may be used for engaging a prosthetic device.

As used herein, the term “undercut” refers to the angle and/or curvature of a natural or prosthetic tooth.

### BACKGROUND

A removable partial dental prosthesis is a device used to replace missing upper or lower teeth when a full denture is not needed because the patient still has teeth on the upper or lower arch which can be used to support the prosthetic teeth.

It is known in the art that metal, nylon, and acrylic may be used as a framework to support prosthetic teeth. When metal framework is used, the prosthetic teeth are held into place with a mechanical bond, resulting in crevices and contours which are difficult to clean and can allow bacteria to grow. The use of a metal framework is undesirable because metal is slightly invasive and may cause an allergic reaction or other health problems. Metal may also react with foods; is difficult to clean; is rigid, uncomfortable, breakable, and unattractive; and can damage the patient's teeth. In addition, metal framework is difficult to alter and requires welding for subsequent addition of prosthetic teeth.

Dental prostheses with a nylon framework are strong and flexible; however, they also utilize a mechanical bond to secure the prosthetic teeth to the framework. In addition, subsequent prosthetic teeth cannot be added to the existing framework, rather a whole new prosthetic must be made.

Dental prostheses which have an acrylic framework, such as Astron's Ultraflex™, are also undesirable. While acrylic is non-allergenic and more aesthetically appealing than metal, it still may require the placement of metal clasp components to grasp the surrounding natural teeth. In addition, acrylic is not as strong as metal or nylon, has varying degrees of rigidity, and is not sufficiently flexible, resulting in frequent breakage.

When an acrylic framework is used, the prosthetic teeth are held into place with a chemical bond. In order for the chemical bond to be strong enough, the material must be thick, which can be uncomfortable and make it difficult for the patient to talk.

It is desirable to have a removable partial dental prosthesis that is strong.

It is desirable to have a removable partial dental prosthesis that is flexible, adding comfort and preventing breakage.

It is further desirable to have a removable partial dental prosthesis that utilizes chemical bonding.

### SUMMARY OF THE INVENTION

The present invention is a removable partial dental prosthesis comprised of a plastic framework. One or more acrylic prosthetic teeth are chemically bonded to the framework using dental acrylic.

### DETAILED DESCRIPTION OF INVENTION

For the purpose of promoting an understanding of the present invention, references are made in the text to exemplary embodiments of a removable partial dental prosthesis, only some of which are described herein. It should be understood that no limitations on the scope of the invention are intended by describing these exemplary embodiments. One of ordinary skill in the art will readily appreciate that alternate but functionally equivalent materials, configurations, and processes may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

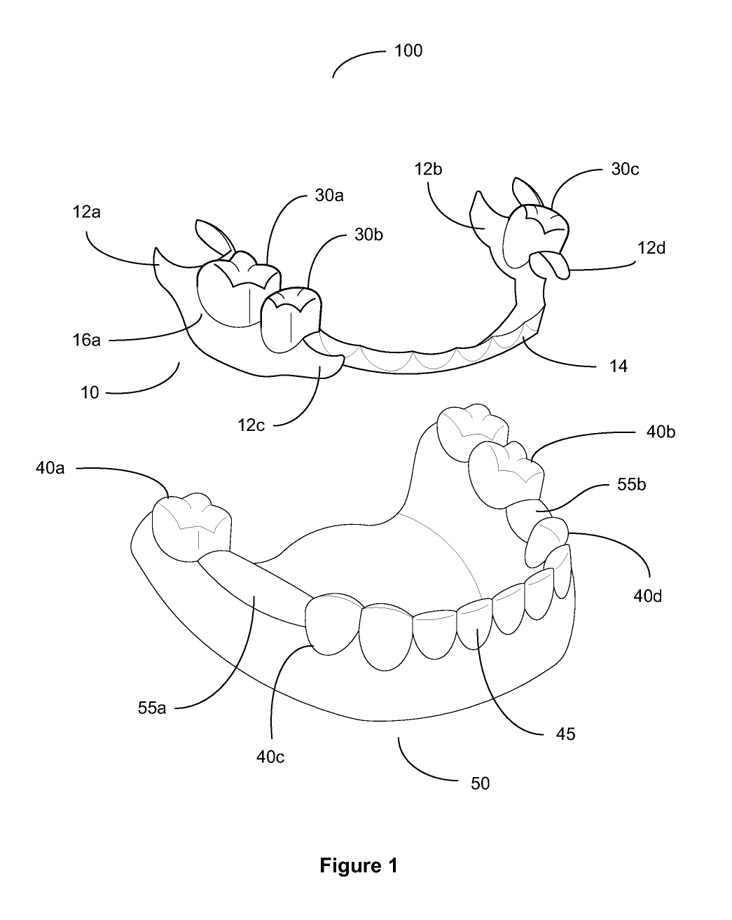

FIG. 1 illustrates an exploded view of an exemplary embodiment of removable partial dental prosthesis 100 and model 50, which is a partial replica of a specific patient's teeth and gums. Removable partial dental prosthesis 100 is comprised of framework 10, prosthetic teeth 30a, 30b, 30c, and dental acrylic 20 (not visible), which is used to secure prosthetic teeth 30a, 30b, 30c to framework 10.

In the embodiment shown, framework 10 has major connector 14, bonding surfaces 16a, 16b for attaching prosthetic teeth 30a, 30b, 30c to framework 10, and clasps 12a, 12b, 12c, 12d. When removable partial dental prosthesis 100 is positioned on model 50, major connector 14 abuts against the back of a portion of teeth/gums 45, while clasps 12a, 12b, 12c, 12d engage abutment teeth 40a, 40b, 40c, 40d of model 50.

In the embodiment shown, the location of prosthetic teeth 30a, 30b, 30c correspond to the location of missing teeth on model 50. When removable partial dental prosthesis 100 is placed on model 50, prosthetic teeth 30a, 30b, 30c are supported by supporting tissue of gaps 55a, 55b.

In other embodiments, the number and location of prosthetic teeth may vary as removable partial dental prosthesis 100 is specific to each patient.

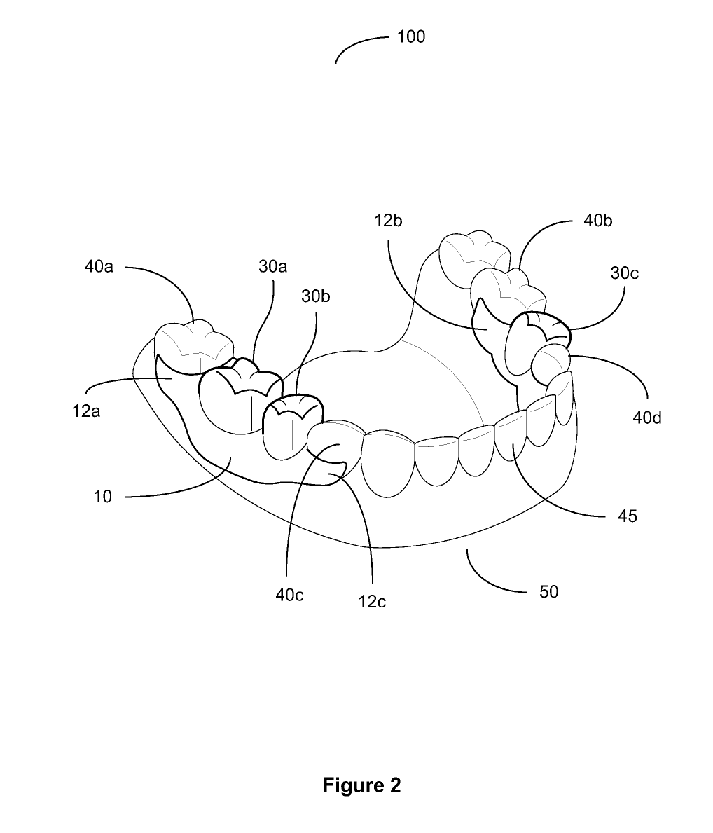

FIG. 2 illustrates a top perspective view of an exemplary embodiment of a removable partial dental prosthesis 100 fitted on model 50. When removable partial dental prosthesis 100 is fitted on model 50, prosthetic teeth 30a, 30b, 30c are positioned in gaps 55a, 55b, major connector 14 (not visible) abuts the back of teeth/gums 45, and clasps 12a, 12b, 12c, 12d (12d not visible) engage abutment teeth 40a, 40b, 40c, 40d.

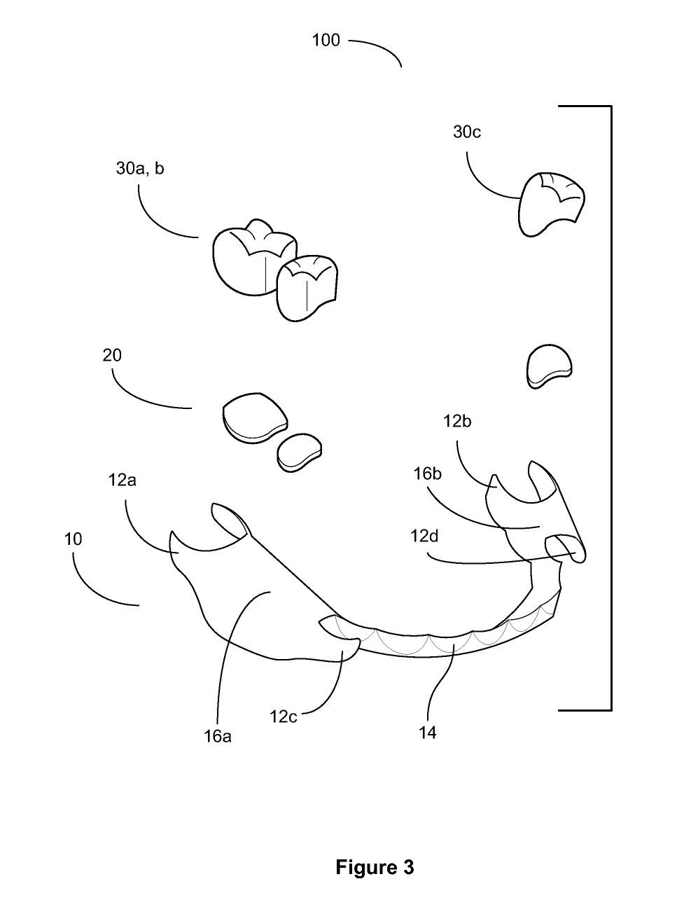

FIG. 3 illustrates an exploded view of an exemplary embodiment of removable partial dental prosthesis 100. After a model is made of a patient's mouth, the model is analyzed to facilitate a path of insertion. Framework 10 is then formed by placing a layer of thermosetting plastic over the model. In the embodiment shown, framework 10 is comprised of a thermosetting plastic that has a thickness ranging from 1.5 to 2.0 mm. In various embodiments, framework 10 may be comprised of CLEARsplint™ (Astron) or any other material having the desired properties.

The use of a thermosetting plastic for framework 10 provides the desired flexibility and comfort, and is non-abrasive to the patient's teeth and gums. In an exemplary embodiment, framework 10 is clear, making it more aesthetically appealing. In various other embodiments, framework 10 may be a color other than clear.

Framework 10 is then shaped by removing all material that is not necessary to engage the patient's teeth and gums or to bond prosthetic teeth 30a, 30b, 30c. Bonding surfaces 16a, 16b are then primed using glass beads, sandblasting or any other method known in the art for creating an abrasive surface for adherence prior to the positioning of prosthetic teeth 30a, 30b, 30c. Prosthetic teeth 30a, 30b, 30c are then positioned on bonding surfaces 16a, 16b and chemically bonded using dental acrylic 20. In an exemplary embodiment, prosthetic teeth 30a, 30b, 30c are comprised of acrylic, but in various embodiments, prosthetic teeth 30a, 30b, 30c may be comprised of porcelain, ceramic or any other material known in the art.

In an exemplary embodiment, dental acrylic 20 is comprised of a monomer (liquid) and a polymer (powder) known in the art that are mixed prior to use. Dental acrylic 20 is then heat-cured. In various other embodiments, dental acrylic 20 may be cold-cured. When cured, dental acrylic 20 chemically bonds prosthetic teeth 30a, 30b, 30c to framework 10.

In an exemplary embodiment, dental acrylic 20 is pink to blend in with the patient's gums when being worn by the patient. In various other embodiments, framework 10 may be a color other than pink.

Using dental acrylic 20 to chemically bond prosthetic teeth 30a, 30b, 30c eliminates the cracks and crevices characteristic of a mechanical bond, which are difficult to clean and allow bacteria growth. In addition, dental acrylic 20 provides a strong bond between framework 10 and prosthetic teeth 30a, 30b, 30c without adding bulkiness or substantial weight to removable partial dental prosthesis 100. Additionally, major connector 14 is much thinner than structures known in the prior art, increasing comfort and flexibility. In various embodiments, removable partial dental prosthesis 100 may be subsequently modified. For example, one or more additional prosthetic teeth may be added to framework 10.

In an exemplary embodiment, the materials required to make removable partial dental prosthesis 100 may be available in a kit. For example, a kit may include a plurality of sheets of thermosetting plastic in an optimal thickness for forming framework 10, a plurality of prosthetic teeth 30, and dental acrylic 20. In an exemplary embodiment, the preferred thickness for forming framework 10 is approximately 1.5 to 2 mm.

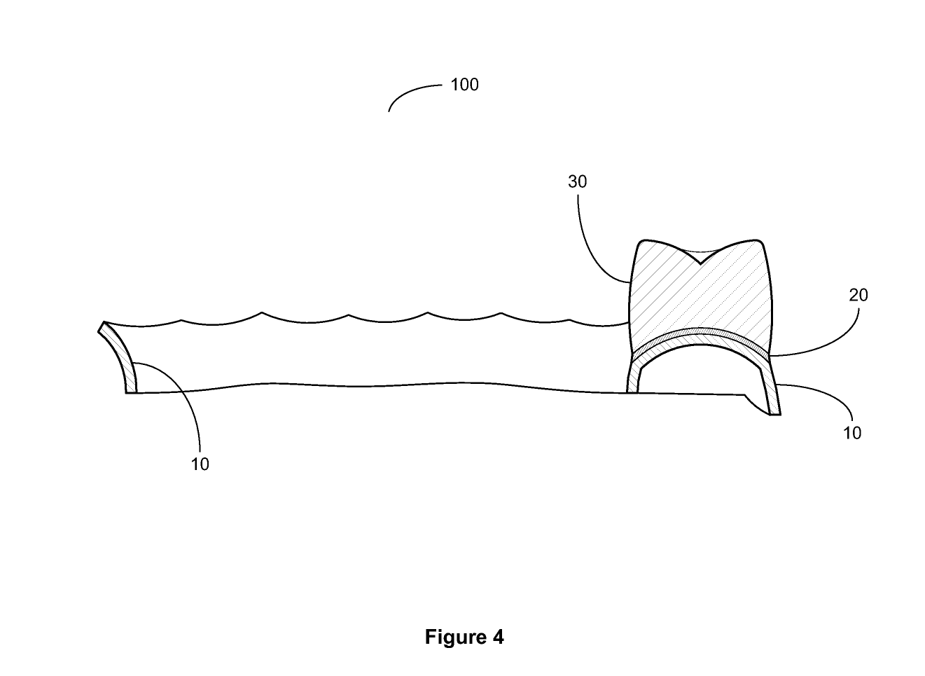

FIG. 4 illustrates a sectional view of an exemplary embodiment of removable partial dental prosthesis 100 showing framework 10, dental acrylic 20, and prosthetic tooth 30.

What is claimed is:

1. A removable partial prosthetic dental device comprised of:
a framework comprised of a plastic base material;
at least one prosthetic tooth; and
a bonding substance used to bond said at least one prosthetic tooth to said framework.

2. The device of claim 1 wherein said bonding substance is dental acrylic.

3. The device of claim 1 wherein said bonding substance is comprised of a combination of plastic and acrylic.

4. The device of claim 1 wherein said bonding substance is tinted.

5. The device of claim 1 wherein said prosthetic tooth is ceramic.

6. The device of claim 1 wherein said prosthetic tooth is comprised of a combination of plastic and acrylic.

7. The device of claim 1 wherein said plastic base material is a thermosetting plastic.

8. The device of claim 1 wherein said plastic base material has a thickness of 1.5 mm.

9. The device of claim 1 wherein said plastic base material has a thickness of 2.0 mm.

10. The device of claim 1 wherein said plastic base material has a thickness ranging from 1.2 to 2.4 mm.

11. The device of claim 1 wherein said dental acrylic is comprised of a monomer and a polymer.

12. The device of claim 1 wherein said dental acrylic is pink.

13. The device of claim 1 wherein said dental acrylic is heat-cured.

14. The device of claim 1 wherein said dental acrylic is cold-cured.

15. The device of claim 1 wherein said framework has a textured upper surface.

16. The device of claim 1 wherein additional prosthetic teeth can be added to said device after said device has been formed.

17. A kit for making a partial prosthetic dental device comprised of:
a plurality of sheets of plastic base material for forming a framework;
a plurality of acrylic teeth; and
dental acrylic, said dental acrylic is used to bond said at least one acrylic tooth to said framework.

18. A method for making a removable partial prosthetic device comprised of:
making a model of a patient's mouth;
surveying and adjusting said model to facilitate a path of insertion;
forming a layer of thermosetting plastic over said model to form a plastic frame having a top surface and a bottom surface;
cutting said layer of thermosetting plastic to remove all plastic material which is not necessary to engage said patient's teeth and gums, leaving a portion of said layer of thermosetting plastic in place so that one or more acrylic teeth may be bonded to said top surface;
priming a portion of said top surface where said one or more acrylic teeth are to be bonded;
positioning said acrylic teeth on said primed portion of said top surface; and
chemically binding said one or more acrylic teeth to said top surface with dental acrylic.

19. The method of claim 18 wherein glass beads are used to prime said portion of top surface where said one or more acrylic teeth are to be bonded.

20. The device of claim 18 which further includes mixing a monomer and polymer to form said dental acrylic.
